(19) United States
(12) Patent Application Publication
(10) Pub. No.: US 2005/0209404 A1
(43) Pub. Date: Sep. 22, 2005

(54) Film and image display device utilizing same

(75) Inventors: Seiya Sakurai, Minami-ashigara-shi (JP); Hirohisa Hokazono, Minami-ashigara-shi (JP); Mizuki Yamamoto, Minami-ashigara-shi (JP)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(73) Assignee: Fuji Photo Film Co., Ltd., Minami-ashigara-shi (JP)

(21) Appl. No.: 11/056,296

(22) Filed: Feb. 14, 2005

(30) Foreign Application Priority Data
Feb. 13, 2004 (JP) 2004-036741

(51) Int. Cl. G03G 15/02

(52) U.S. Cl. 525/199

(57) ABSTRACT

A film comprising a polyarylate containing a repeating unit represented by 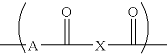
wherein X represents a bridging group represented by either one of 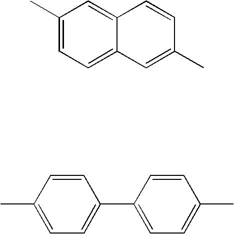
and A represents a bridging group represented by 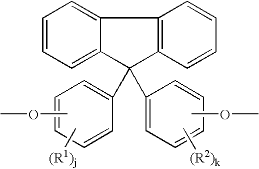
wherein R¹ and R² represent an alkyl group or an aryl group, j and k represent 0 to 4, which has heat resistance enabling disposition of various functional layers at a high temperature and also has superior optical characteristics and mechanical characteristics.

### BACKGROUND OF THE INVENTION

1. Field of the Invention

The present invention relates to a film having superior heat resistance, optical characteristics and mechanical characteristics, and an image display device utilizing the film, which shows superior display quality.

2. Description of the Related Art

In the field of flat panel displays such as liquid crystal display devices and organic electroluminescence (EL) devices, replacement of glass substrates with plastic substrates is studied in recent years due to needs of improvement of damage resistance, lighter weight and smaller thickness. Such needs are particularly high for display devices for mobile information communication equipments such as cellular phones and portable information terminals including electronic notes and laptop personal computers.

When a plastics substrate is used to replace a glass substrate, it is required to impart conductivity to the plastics substrate. Therefore, it is examined to use, as an electrode substrate of a display device, a transparent conductive substrate obtained by providing a semiconductor film consisting of indium oxide, tin oxide, oxide of tin/indium alloy or the like, a metal film consisting of gold, silver, palladium alloy or the like or a film formed by combining such semiconductor film and metal film as a transparent conductive layer on a plastic film.

As plastic materials used for this purpose, for example, heat resistant amorphous polymers such as modified polycarbonates (modified PC, see, for example, Japanese Patent Laid-open Publication (Kokai) No. 2000-227603 (claim 7, [0009] to [0019])), polyether sulphones (PES, see, for example, Japanese Patent Laid-open Publication No. 2000-284717 ([0010], [0021] to [0027])) and cycloolefin copolymers (see, for example, Japanese Patent Laid-open Publication No. 2001-150584 ([0027] to [0039])) are known, and substrates comprising these materials laminated with a transparent conductive layer and a gas barrier layer are known.

However, even if these heat resistant plastics are used, sufficient heat resistance as plastic film substrates cannot be obtained. That is, they have a temperature of 150° C. or higher when an alignment layer or the like is provided after a conductive layer is formed on a plastic substrate utilizing any of those heat resistant plastics, conductivity and gas barrier property are markedly degraded. Further, for disposition of TFT in the production of active matrix type image display devices, further higher heat resistance is required.

Japanese Patent Laid-open Publication No. 7-81919 (claim 3, [0016] to [0020]) discloses a method of forming a polycrystalline silicon film at a temperature of 300° C. or lower by plasma decomposition of a gas containing SiH₄. Moreover, International Patent Publication in Japanese (Kohyo) No. 10-512104 (pages 14 to 22, FIG. 1, FIG. 7) describes a method of forming a semiconductor layer mixed with amorphous silicon and polycrystalline silicon on a polymer substrate by irradiation of an energy beam. Furthermore, Japanese Patent Laid-open Publication No. 11-102867 (claims 1 to 10, [0036]) describes a method of forming a polycrystalline silicon semiconductor layer on a plastic substrate provided with a thermal buffer layer by irradiation of a pulsed laser beam. As described above, various methods for forming a polycrystalline silicon film for TFT at a temperature of 300° C. or lower have been proposed. However, because these methods have problems that they use complicated processes and production apparatuses and thus require high cost, heat resistance for a temperature of 300° C. to 350° C. or even higher temperature is desired for use of plastic substrates in the field of flat panel displays.

Japanese Patent Laid-open Publication No. 2003-168800 ([0021]) describes a thin film transistor substrate utilizing a polyimide film derived from an aliphatic tetracarboxylic anhydride. The polyimide film described in example of this publication has superior heat resistance and transparency, i.e., a glass transition temperature (Tg) of 315° C. and total light transmission of 85%. However, this method is not preferred for production for the reasons that the aliphatic tetracarboxylic anhydride used as a raw material is expensive, it requires film formation at a high temperature using a high boiling point solvent, and so forth.

Japanese Patent Laid-open Publication No. 57-192432 (claim 1, page 8, Example 6, table) and Japanese Patent Laid-open Publication No. 3-28222 (claim 1) include descriptions concerning a polyarylate film derived from 9,9-bis(4-hydroxyphenyl)fluorene (also referred to as “bisphenol fluorene” hereinafter), isophthalic acid and terephthalic acid. WO99/18141 (claims 9 to 12) include descriptions concerning a polyarylate film derived from an alkyl-substituted bisphenol fluorene, isophthalic acid and terephthalic acid. These polyarylates derived from an alkyl-substituted or unsubstituted bisphenol fluorene, isophthalic acid and terephthalic acid can be synthesized from inexpensive raw materials and have Tg of about 300° C. or higher, and flexible films having superior transparency and breaking extension can be prepared from them by using a low boiling point solvent such as dichloromethane and cyclohexanone. However, it cannot be considered that they always satisfactorily meet the requirements concerning mechanical characteristics required for plastic substrates.

Japanese Patent Laid-open Publication No. 2002-145998 (claims 1 to 8, examples) describes a polyarylate film derived from bisphenol fluorene substituted with a halogen or the like at the ortho position of the phenol. According to the examples of this publication, polyarylate films derived from orthodibromo- or orthodichloro-substituted bisphenol fluorene, isophthalic acid and terephthalic acid are preferred, because they are formed as films by using dichloromethane, which is a low boiling point solvent, and have superior heat resistance. However, when a conductive film, semiconductor film or the like is disposed on the aforementioned polyarylate films, they are exposed to a high temperature. Therefore, they may generate halogen ions, and thereby electrical characteristics of the conductive film and semiconductor film may be degraded.

As described above, films utilizing polyarylates derived from a bisphenol fluorene derivative, isophthalic acid and terephthalic acid enable easy film formation by using a low boiling point solvent such as dichloromethane, and have superior transparency, breaking extension and heat resistance represented by Tg of about 300° C. However, the aforementioned polyarylate films do not necessarily meet the requirements of being halogen-free materials and further improved heat resistance and mechanical characteristics.

Japanese Patent Laid-open Publication No. 2000-131858 (claims 1 to 7) include descriptions concerning an electrophotographic photosensitive material utilizing a polyarylate derived from a bisphenol fluorene derivative and naphthalenedicarboxylic acid. However, this polyarylate aims at improvement of wear resistance and durability as a binder resin of a charge transport layer, and applications thereof to films are not suggested at all.

### SUMMARY OF THE INVENTION

The present invention is achieved in order to solve the aforementioned problems, and an object of the present invention is to provide a film having heat resistance that enables disposition of various functional layers at a high temperature and also has superior optical characteristics and mechanical characteristics.

Another object of the present invention is to provide an image display device utilizing such a film as described above and showing superior display quality.

The inventors of the present invention conducted various researches concerning heat resistance, optical characteristics and mechanical characteristics of polyarylate from the viewpoint of structure of polyarylate.

As a result, they found that all of the requirements of heat resistance, optical characteristics and mechanical characteristics could be satisfied by a film comprising a polyarylate having a particular structure, and accomplished the present invention. The objects of the present invention are achieved by the followings.
(1) A film comprising a polyarylate containing a repeating unit represented by the formula (1): 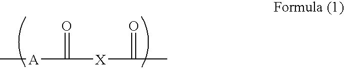
   wherein, in the formula (1), X represents a bridging group having the naphthalene or biphenyl structure represented by either one of the following structures: 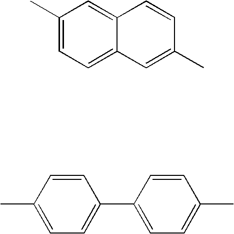
   and A represents a bridging group represented by the following formula (2): 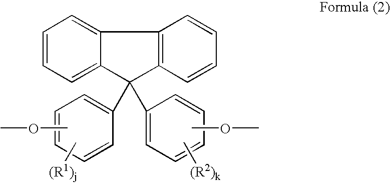
   wherein, in the formula (2), R¹ and R² independently represent an alkyl group or an aryl group, j and k independently represent an integer of 0 to 4, and when j and/or k is 2 or larger, two or more of R¹ and/or R² may be the same or different, provided that when j and/or k is 2 or larger, and R¹ and/or R² existing on one of the ortho positions on the aromatic rings with respect to the oxygen atoms represented by —O— is phenyl group, hydrogen atom exists on the other ortho positions.
(2) The film according to (1), wherein the polyarylate contains two or more kinds of repeating units represented by the formula (1).
(3) The film according to (1) or (2), wherein the polyarylate has a glass transition temperature of 300° C. or higher.
(4) The film according to any one of (1) to (3), which has a total light transmission of 80% or higher.
(5) The film according to any one of (1) to (4), which is laminated with a gas barrier layer on at least one side.
(6) The film according to any one of (1) to (5), which is laminated with a transparent conductive layer on at least one side.
(7) An image display device utilizing the film according to any one of (1) to (6).

The film of the present invention comprises a polyarylate containing a repeating unit represented by the aforementioned formula (1). By this characteristic, the film of the present invention can have superior heat resistance, optical characteristics and mechanical characteristics. Moreover, when a gas barrier layer and/or a transparent conductive layer is disposed on the film of the present invention, good gas barrier property and conductivity can be obtained even if it is subjected to a high temperature treatment.

Furthermore, by using the image display device of the present invention, a flat panel display such as liquid crystal displays and organic electroluminescence displays showing superior display quality can be provided, since it utilizes the aforementioned film as a substrate.

### BEST MODE FOR CARRYING OUT THE INVENTION

Hereafter, the film and image display device utilizing the film according to the present invention will be explained in detail. The ranges expressed with “to” are used in the present specification to mean ranges including the numerical values indicated before and after “to” as lower limit values and upper limit values.

[Film]

The film of the present invention is a film comprising a polyarylate containing a repeating unit represented by the following formula (1) (hereinafter, also referred to as the “polyarylate of the present invention”).

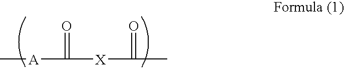

In the formula (1), X represents a bridging group having the naphthalene or biphenyl structure represented by either one of the following structures: 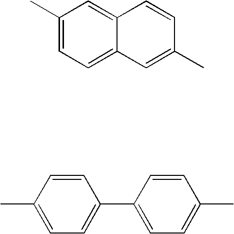
and A represents a bridging group represented by the following formula (2):
Formula (2)

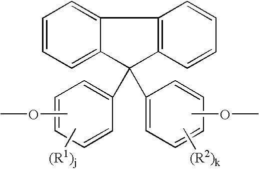

In the formula (2), R¹ and R² independently represent an alkyl group or an aryl group, j and k independently represent an integer of 0 to 4, and when j and/or k is 2 or larger, two or more of R¹ and/or R² may be the same or different.

R¹ and R² preferably represent, for example, at least one kind of group selected from methyl group, ethyl group, n-propyl group, isopropyl group, n-butyl group, isobutyl group, sec-butyl group, tert-butyl group, cyclohexyl group, phenyl group and naphthyl group, particularly preferably methyl group.

When j and/or k is 2 or larger, and R¹ and/or R² existing on one of the ortho positions on the aromatic rings with respect to the oxygen atoms represented by —O— is phenyl group, hydrogen atom exists on the other ortho positions.

Preferred examples of the bridging group represented by the formula (2) are shown below in the forms of bisphenol compounds. However, the present invention is not limited to these.

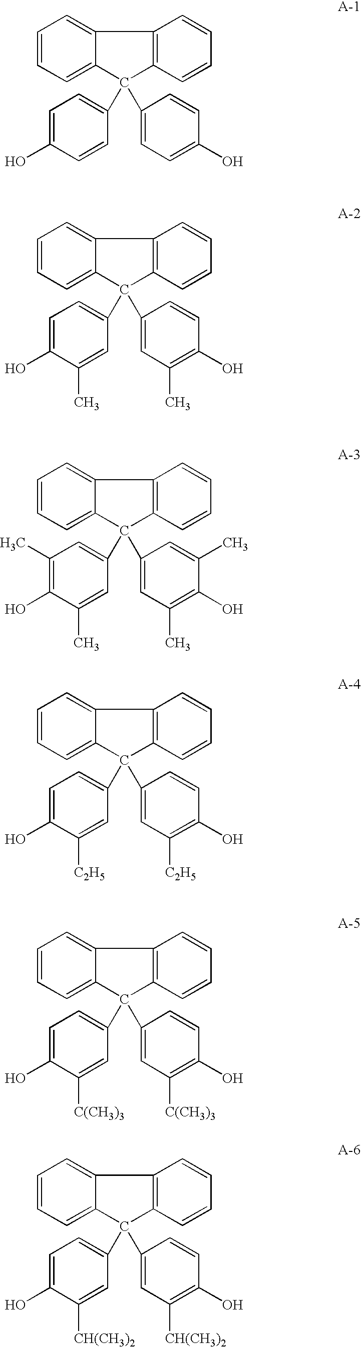

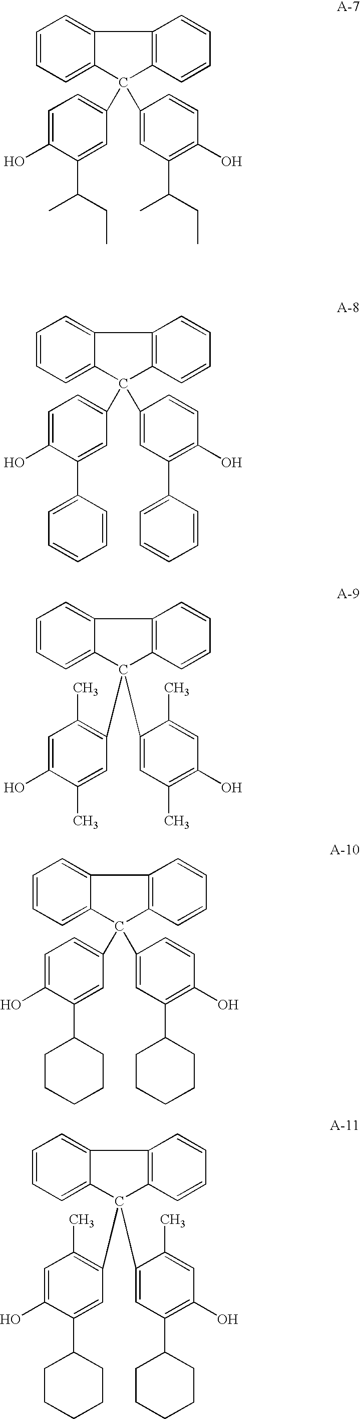

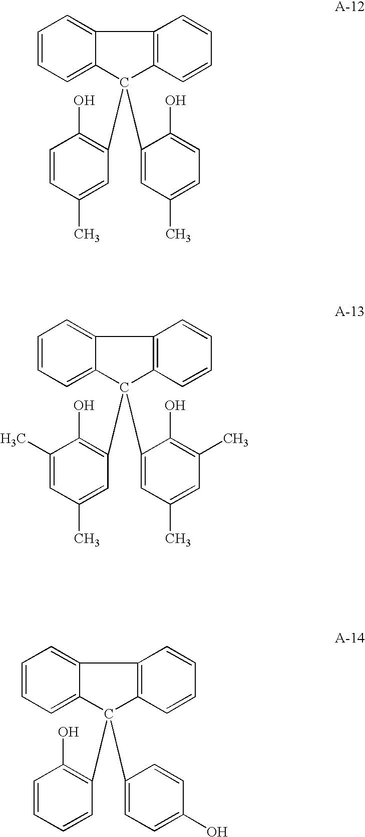

In view of heat resistance, A-1, A-2 and A-3 are particularly preferred among the bridging groups represented by the general formula (2) shown above.

The polyarylate used in the present invention preferably contains two or more kinds of repeating units represented by the formula (1) in view of heat resistance and transparency. For example, those obtained by polymerizing two or more kinds of monomers having structures selected from those represented by A-1 to A-14 mentioned above at an arbitrary ratio as bridging groups can be mentioned.

Furthermore, the polyarylate used in the present invention is preferably copolymerized with a dicarboxylic acid other than 2,6-naphthalenedicarboxylic acid and 4,4′-biphenyldicarboxylic acid in such a degree that heat resistance should not be degraded. Preferred examples of copolymerizable dicarboxylic acid include, for example, terephthalic acid, isophthalic acid, 2,7-naphthalenedicarboxylic acid, diphenic acid and so forth. Particularly preferred example is terephthalic acid. Further, various known bisphenol compounds may also be copolymerized in such a degree that heat resistance and transparency should not be degraded.

A higher heat resistance temperature of the polyarylate used in the present invention is more preferred, and it can be tentatively determined by using a glass transition temperature measured by DSC measurement. This glass transition temperature is preferably 250° C. or higher, more preferably 300° C. or higher, particularly preferably 330° C. or higher. Moreover, a polyarylate of which glass transition temperature is not substantially observed within a measurable range (for example, 400° C. or lower) is also included in the scope of the polyarylate of the present invention.

The polyarylate used in the present invention preferably has a molecular weight of 10,000 to 500,000, more preferably 20,000 to 300,000, particularly preferably 30,000 to 200,000, in terms of weight average molecular weight. If the molecular weight is lower than 10,000, film formation may become difficult, and mechanical characteristics may be degraded. On the other hand, if the molecular weight exceeds 500,000, it becomes difficult to control the molecular weight in the synthesis, and handling may become difficult due to unduly high viscosity of a solution of the polyarylate. The molecular weight can also be tentatively determined according to corresponding viscosity.

The polyarylate used in the present invention preferably has a carboxyl value of 300 μmol/g or less, more preferably 100 μmol/g or less, still more preferably 30 μmol/g or less, particularly preferably 10 μmol/g or less. If the carboxyl value exceeds 300 μmol/g, for example, electrical characteristics such as anti-arc discharge property and dielectric constant may be adversely affected, storage stability of a polymer solution prepared by dissolving the polymer in a solvent may be adversely affected, and surface properties of the cast film obtained by the solution casting method may be adversely affected. The carboxyl value of the polyarylate can be measured by a known method such as neutralization titration using a potentiometric titration apparatus.

The amounts of alkali metals and halogens remained in the polyarylate used in the present invention are preferably 50 ppm or less, particularly preferably 10 ppm or less. If the amounts of residual alkali metals and halogens exceed 50 ppm, the aforementioned electrical characteristics may tend to be degraded, surface properties of the film may be adversely affected, and performance degradation of a disposed functional film such as conductive film and semiconductor film may be caused. The amounts of residual alkali metals and halogens remained in the polyarylate may be quantified by a known method such as ion chromatography analysis, atomic absorption spectrometry and plasma emission spectrometry.

Further, the amount of catalyst such as quaternary ammonium salts and quaternary phosphonium salts remained in the polyarylate used in the present invention is preferably 200 ppm or less, more preferably 100 ppm or less. If the amount of residual catalyst exceeds 200 ppm, the aforementioned electrical characteristics may tend to be degraded, surface properties of the film may be adversely affected, and performance degradation of a disposed functional film such as conductive film and semiconductor film may be caused. The amount of catalyst such as quaternary ammonium salts and quaternary phosphonium salts remained in the polyarylate may be quantified by a known method such as HPLC and gas chromatography.

Furthermore, the amounts of phenol monomers and dicarboxylic acids remained in the polyarylate used in the present invention is preferably 3000 ppm or less, more preferably 500 ppm or less, still more preferably 100 ppm or less. If the amounts of residual phenol monomers and dicarboxylic acids exceed 3000 ppm, the aforementioned electrical characteristics may tend to be degraded, surface properties of the film may be adversely affected, and performance degradation of a disposed functional film such as conductive film and semiconductor film may be caused. More specifically, for example, when a transparent conductive film is formed on the film, gas of residual phenol monomers and carboxylic acid components may be generated due to influences by heating, plasma or the like at the time of film formation, aggregations of crystal particles may be generated because pyrolysis or the like is caused, or uncoated portions called “nuke (omission)” may be generated in the transparent conductive layer, and they may inhibit the transparent conductive film from getting lower resistance, and so forth. Therefore, the amounts of residual phenol monomers and dicarboxylic acids are preferably made 3000 ppm or less. The amounts of phenol monomers and dicarboxylic acids remained in the polyarylate or a film thereof may be quantified by a known method such as HPLC and nuclear magnetic resonance measurement.

The repeating unit represented by the formula (1) is preferably contained in the polyarylate used in the present invention at a molar percentage of 5 to 100%, more preferably 10 to 100%, still more preferably 20 to 100%.

Hereafter, synthesis method of the polyarylate containing a repeating unit represented by the formula (1) will be explained.

The aforementioned polyarylate can be obtained by polycondensation of unsubstituted bisphenol fluorene or a bisphenol fluorene substituted with an alkyl group or aryl group, and 2,6-naphthalenedicarboxylic acid or 4,4′-biphenyldicarboxylic acid.

As the polycondensation method, any of known methods such as a melt polycondensation method based on decarboxylation, melt polycondensation method based on dephenolation, dehydrochlorination homogeneous polymerization method performed in an organic solvent system in which the dicarboxylic acid compound is used as an acid chloride and an organic base is used to make the polymer soluble, and interfacial polycondensation method performed in a two phase system of an aqueous alkaline solution and water-immiscible organic solvent by using the dicarboxylic acid compound as an acid chloride can be used. When Tg of the aforementioned polyarylate is 300° C. or higher, polymerization based on melt polycondensation is difficult. However, polymerization can be attained at a temperature of about 300° C. by using together, for example, such a high boiling point plasticizer as disclosed in Japanese Patent Laid-open Publication No. 7-188405.

For the synthesis of the polyarylate used in the present invention, polymerization based on interfacial polycondensation is convenient and thus preferred. However, typical known interfacial polycondensation methods employ, as exemplified by a method using bisphenol A, terephthalic acid and isophthalic acid, a method of dissolving a bisphenol compound in an aqueous alkaline solution, further dissolving a dicarboxylic acid chloride in a water-immiscible organic solvent (typically dichloromethane etc.) and mixing them in short time. However, in the present invention, solubility of the bisphenol compound in an aqueous alkaline solution may be low. Moreover, in the present invention, solubility of 2,6-naphthalenedicarboxylic acid chloride in a water-immiscible organic solvent is low, and the polyarylate containing the repeating unit represented by the aforementioned formula (1) may not be synthesized by a known method. Therefore, in the present invention, a method in which water, water-immiscible organic solvent, bisphenol compound and dicarboxylic acid chloride are mixed by stirring to form a slurry-like mixture beforehand, and an aqueous alkaline solution of a high concentration is gradually added to the mixture is effective for obtaining a higher molecular weight. The details of this method will be described later by referring to synthesis examples.

The molecular weight of the polyarylate used in the present invention can be controlled by adding a monofunctional substance during the polymerization without using the aforementioned production method. Examples of the monofunctional substance used above as a molecular weight controlling agent include monovalent phenols such as phenol, cresol and p-tert-butylphenol, monovalent acid chlorides such as benzoyl chloride, methanesulfonyl chloride and phenyl chloroformate, monohydric alcohols such as methanol, ethanol, n-propanol, isopropanol, n-butanol, pentanol, hexanol, dodecyl alcohol, stearyl alcohol, benzyl alcohol and phenethyl alcohol, monobasic carboxylic acids such as acetic acid, propionic acid, octanoic acid, cyclohexanecarboxylic acid, benzoic acid, toluic acid, phenyl acid, p-tert-butylbenzoic acid and p-methoxyphenylacetic acid and so forth.

Preferred example of the polyarylate containing the repeating unit represented by the aforementioned formula (1) will be mentioned below using bisphenol and dicarboxylic acid units. However, the present invention is not limited to these.

The bisphenol compounds exemplified above are mentioned with the numbers thereof, 2,6-naphthalenedicarboxylic acid is represented as X-1, and 4,4′-biphenyldicarboxylic acid is represented as X-2. When two or more kinds of bisphenol compounds or dicarboxylic acid compounds are used, molar ratios thereof are also mentioned.

TABLE 1

| Polyarylate | Monomer | Molar ratio |
|---|---|---|
| P-1 | A-1/X-1 | 100/100 |
| P-2 | A-2/X-1 | 100/100 |
| P-3 | A-3/X-1 | 100/100 |
| P-4 | A-1/X-2 | 100/100 |
| P-5 | A-2/X-2 | 100/100 |
| P-6 | A-3/X-2 | 100/100 |
| P-7 | A-1/A-2/X-1 | 50/50/100 |
| P-8 | A-1/A-2/X-1 | 75/25/100 |
| P-9 | A-1/A-3/X-1 | 50/50/100 |
| P-10 | A-2/A-3/X-1 | 50/50/100 |
| P-11 | A-1/X-1/X-2 | 100/50/50 |
| P-12 | A-1/X-1/X-2 | 100/75/25 |
| P-13 | A-1/A-6/X-1 | 90/10/100 |
| P-14 | A-1/A-8/X-1 | 90/10/100 |
| P-15 | A-1/A-12/X-1 | 95/5/100 |
| P-16 | A-1/A-14/X-1 | 96.7/3.3/100 |
| P-17 | A-1/X-1/2,7-Naphthalenedicarboxylic acid | 100/50/50 |
| P-18 | A-1/X-1/2,7-Naphthalenedicarboxylic acid | 100/75/25 |
| P-19 | A-1/X-1/Terephthalic acid | 100/50/50 |
| P-20 | A-1/X-1/Isophthalic acid | 100/75/25 |
| P-21 | A-1/X-2/Terephthalic acid | 100/50/50 |
| P-22 | A-3/X-1/Terephthalic acid | 100/50/50 |
| P-23 | A-3/X-2/Terephthalic acid | 100/50/50 |

Synthesis examples of the polyarylates of the present invention will be shown below. However, the present invention is not limited to these.

### SYNTHESIS EXAMPLE 1

### Synthesis of Compound P-1

BPFL (trade name) produced by JFE Chemical was recrystallized twice from acetonitrile and vacuum-dried at 70° C. for 3 hours with heating to obtain A-1 having an HPLC purity of 99.9% or higher (except for acetonitrile contained in an amount of 8.6 weight %).

The obtained A-1 containing 8.6 weight % of acetonitrile (253.03 g, 660 mmol), tetrabutylammonium chloride (9.171 g, 33 mmol), dichloromethane (2805 mL) and water (2475 mL) were put into a reaction vessel provided with a stirrer and stirred at a stirring rate of 300 rpm on a water bath under a nitrogen flow. After 30 minutes, 2,6-naphthalenedicarboxylic acid chloride (167.03 g, 660 mmol) was added as powder and washed out with 330 mL of dichloromethane. After 10 minutes, 693 mL of a solution of 2 M (2 N) aqueous sodium hydroxide diluted with 132 mL of water was added dropwise over 1 hour using a dropping apparatus, and after completion of the addition, it was washed off with 165 mL of water. Subsequently, stirring was continued for 3 hours, and then dichloromethane (1 L) was added. The organic phase was separated, and a solution obtained by diluting 6.6 mL of 12 M (12 N) aqueous hydrochloric acid with 2.5 L of water was added to the organic phase for washing. The organic phase was further washed twice with 2.5 L of water. Then, dichloromethane (1 L) was added to the separated organic phase for dilution, and the diluted organic phase was poured into vigorously stirred methanol (25 L) over 1 hour.

The obtained white precipitates were collected by filtration and dried by heating at 40° C. for 12 hours and then at 70° C. for 3 hours under reduced pressure to obtain 302 g of Compound P-1.

The molecular weight of the obtained Compound P-1 was measured by GPC (solvent: THF) and found to be 170,000 in terms of weight average molecular weight. Further, Tg of Compound P-1 measured by DSC was 369° C.

### SYNTHESIS EXAMPLE 2

### Synthesis of Compound P-1 Having Different Molecular Weight

A-1 containing 8.6 weight % of acetonitrile (247.97 g, 646.8 mmol), which was obtained in Synthesis Example 1, tetrabutylammonium chloride (9.171 g, 33 mmol), dichloromethane (2805 mL) and water (2475 mL) were put into a reaction vessel provided with a stirrer and stirred at a stirring rate of 300 rpm on a water bath under a nitrogen flow. After 30 minutes, 2,6-naphthalenedicarboxylic acid chloride (167.03 g, 660 mmol) was added as powder and washed out with 330 mL of dichloromethane. After 10 minutes, a solution obtained by dissolving p-tert-butylphenol (3.966 g, 26.4 mmol) in 693 mL of 2 M (2 N) aqueous sodium hydroxide and diluting the solution with 132 mL of water was added dropwise over 1 hour using a dropping apparatus. After completion of the addition, the reaction mixture was washed with 165 mL of water. Subsequently, stirring was continued for 3 hours, and then dichloromethane (1 L) was added. The organic phase was separated, and a solution obtained by diluting 6.6 mL of 12 M (12 N) aqueous hydrochloric acid with 2.5 L of water was added to the organic phase for washing. The organic phase was further washed twice with 2.5 L of water. Then, dichloromethane (1 L) was added to the separated organic phase for dilution, and then the diluted organic phase was poured into vigorously stirred methanol (25 L) over 1 hour. The white precipitates obtained in methanol were collected by filtration and dried by heating at 40° C. for 12 hours and then at 70° C. for 3 hours under reduced pressure to obtain 314 g of Compound P-1.

The molecular weight of the obtained Compound P-1 was measured by GPC (solvent: THF) and found to be 51,000 in terms of weight average molecular weight. Further, Tg of this Compound P-1 measured by DSC was 345° C.

### SYNTHESIS EXAMPLE 3

### Synthesis of Compound P-16

According to the method described in Japanese Patent Laid-open Publication No. 8-253437, Example 1, a mixture of A-1 and A-14 was obtained. From this mixture, A-14 was isolated by column chromatography (eluate: hexane/ethyl acetate=8/2 (volume ratio)).

A-14 obtained above (7.632 g, 21.8 mmol), A-1 containing 8.6 weight % of acetonitrile (244.68 g, 638.2 mmol), which was obtained in Synthesis Example 1, tetrabutylammonium chloride (9.171 g, 33 mmol), dichloromethane (2805 mL) and water (2475 mL) were put into a reaction vessel provided with a stirrer and stirred at a stirring rate of 300 rpm on a water bath under a nitrogen flow. After 30 minutes, 2,6-naphthalenedicarboxylic acid chloride (167.03 g, 660 mmol) was added as powder and washed out with 330 mL of dichloromethane. After 10 minutes, a solution of 2 M (2 N) aqueous sodium hydroxide (693 mL) diluted with 132 mL of water was added dropwise over 1 hour using a dropping apparatus, and after completion of the addition, it was washed off with 165 mL of water. Subsequently, stirring was continued for 3 hours, and then dichloromethane (1 L) was added. The organic phase was separated, and a solution obtained by diluting 6.6 mL of 12 M (12 N) aqueous hydrochloric acid with 2.5 L of water was added to the organic phase for washing. The organic phase was further washed twice with 2.5 L of water. Then, dichloromethane (1 L) was added to the separated organic phase for dilution, and then the diluted organic phase was poured into vigorously stirred methanol (25 L) over 1 hour. The white precipitates obtained in methanol were collected by filtration and dried by heating at 40° C. for 12 hours and then at 70° C. for 3 hours under reduced pressure to obtain 308 g of Compound P-16.

The molecular weight of the obtained Compound P-16 was measured by GPC (solvent: THF) and found to be 258,000 in terms of weight average molecular weight. Further, Tg of Compound P-16 measured by DSC was 361° C.

Hereafter, the method for molding the aforementioned polyarylate into a film will be explained.

Although known methods can be employed as a method for molding the polyarylate used in the present invention into a film or sheet, and the solution casting method can be mentioned as a preferred method. The casting and drying processes of the solution casting method are described in U.S. Pat. Nos. 2,336,310, 2,367,603, 2,492,078, 2,492,977, 2,492,978, 2,607,704, 2,739,069, 2,739,070, British Patent Nos. 640,731, 736,892, Japanese Patent Publication (Kokoku) Nos. 45-4554, 49-5614, Japanese Patent Laid-open Publication Nos. 60-176834, 60-203430 and 62-115035.

Examples of production apparatus used for the production by solution casting method include the production apparatuses described in Japanese Patent Laid-open No. 2002-189126, paragraphs [0061] to [0068], FIG. 1, FIG. 2 and so forth. However, the present invention is not limited to use of these apparatuses.

In the solution casting method, the aforementioned polyarylate is dissolved in a solvent. Any solvent may be used as the solvent used, so long as a solvent that can dissolve the polyarylate is chosen. However, a solvent that can dissolve solid matter at a concentration of 10% or more at 25° C. is particularly preferred. Further, the solvent used preferably has a boiling point of 200° C. or lower, more preferably 150° C. or lower. When the boiling point is 200° C. or lower, the solvent can be sufficiently dried, and thus residual ratio of the solvent in the film can be lowered. Moreover, a poor solvent may also be mixed in such an extent that the solubility of the polyarylate used in the present invention should not be degraded, and use of a poor solvent may be advantageous in view of peeling of the film after the solution casting or drying rate.

Examples of the aforementioned solvent include methylene chloride, chloroform, tetrahydrofuran, 1,4-dioxane, benzene, cyclohexane, toluene, xylene, anisole, γ-butyrolactone, benzyl alcohol, isophorone, cyclohexanone, cyclopentanone, 1,2-dichloroethane, 1,1,2,2-tetrachloroethane, ethyl acetate, acetone, chlorobenzene, dichlorobenzene, dimethylformamide, methanol, ethanol and so forth. However, the present invention is not limited to use of these solvents. Further, two or more kinds of solvents may be mixed for use, and a mixed solvent is rather preferred in view of compatibility of drying property and solubility. Moreover, use of a mixed solvent may improve transparency of the film of the present invention, and thus it is preferred.

Examples of the mixed solvent include solvents obtained by mixing methylene chloride with one or several kinds of alcohols having 1 to 5 carbon atoms, and such solvents preferably has an alcohol content of 5 to 20 weight % with respect to the total solvent. Preferred examples further include solvents obtained by appropriately mixing ether, ketone and ester having 3 to 12 carbon atoms, and such solvents may contain one or several kinds of alcohols having 1 to 5 carbon atoms.

Further, the solvents exemplified in Japanese Technical Disclosure No. 2001-1745 (Japan Institute of Invention and Innovation), paragraph 6 and so forth are also included in preferred examples.

A solution used for the solution casting desirably has a polyarylate concentration of 5 to 60 weight %, preferably 10 to 40 weight %, more preferably 10 to 30 weight %. If the polyarylate concentration is 5 to 60 weight %, appropriate viscosity can be obtained, which enables easy control of film thickness and provides good film formation property, and therefore unevenness can be reduced. Moreover, by filtering the solution before the solution casting, transmission of the film of the present invention and impurities in the film can also be reduced.

Although the method for solution casting is not particularly limited, a solution can be cast on a flat plate or roller by using a bar coater, T-die, T-die with bar, doctor blade, roller coater, die coater and so forth.

Although the temperature for drying the solvent may vary depending on the boiling point of the solvent used, drying is preferably performed in two stages. For the first stage, drying is performed at 30 to 100° C. until the weight concentration of the solvent becomes 10% or less, more preferably 5% or less. Subsequently, the film is removed from a flat plate or roller, and drying is performed at a temperature not lower than 60° C. and not higher than the glass transition temperature of the resin as the second stage.

As for removal of the film from the flat plate or roller, the film may be removed immediately after the drying of the first stage, or it may be cooled once and then removed.

If drying by heating of the film of the present invention is insufficient, the amount of residual solvent becomes large. Further, if the film of the present invention is unduly heated, pyrolysis of the polyarylate is caused, and the amount of residual phenol monomers becomes large. Furthermore, unduly rapid drying causes quick vaporization of the contained solvent and thus produces defects of bubbles etc. in the film.

Therefore, the amount of residual solvent in the film of the present invention is preferably made 2000 ppm or less, more preferably 1000 ppm or less, still more preferably 100 ppm or less. If the amount of residual solvent exceeds 2000 ppm, surface properties of the film may be degraded to adversely affect surface treatment etc., and performance degradation of a disposed functional film such as conductive film and semiconductor film may be caused. The amount of solvent remaining in the film of the present invention can be quantified by a known method such as gas chromatography.

For the production of the film of the present invention, a method of sequentially performing the solution casting on a rotating drum or band, peeling of film, drying and winding the film up into the form of a roll is preferred. For mechanical transportation of the film in the production, a higher mechanical strength of the film is more preferred. Preferred mechanical strength cannot be generally defined, because preferred mechanical strength may vary depending on the transportation apparatus. However, it may be tentatively defined by using breaking stress and breaking elongation obtained by performing a tensile test of the film. The breaking stress is preferably 50 MPa or higher, more preferably 80 MPa or higher, still more preferably 100 MPa or higher. Because the breaking elongation may vary depending on the sample production conditions etc., it is slightly more unreliable compared with the breaking stress. However, it is preferably 5% or more, more preferably 10% or more, still more preferably 15% or more.

The film of the present invention may be stretched. Stretching provides advantages of improvement of mechanical strengths of the film such as anti-folding strength, and thus improvement of handling property of the film. In particular, a film having an orientation release stress (ASTM D1504, henceforth abbreviated as “ORS”) of 0.3 to 3 GPa along the stretching direction is preferred, because mechanical strength of such a film is improved. ORS is internal stress present in a stretched film or sheet generated by stretching.

Known methods can be used for the stretching. When the polyarylate of the present invention has a glass transition temperature of 300° C. or higher, stretching is difficult only with heating, but such a polyarylate can be stretched in a state that it contains a solvent. In such a case, stretching is preferably performed during the drying process, and it can be performed at a temperature of from a temperature higher than the glass transition temperature (Tg) of the polyarylate by 10° C. to a temperature higher than Tg by 50° C., for example, by the monoaxial stretching method by roller, monoaxial stretching method by tenter, simultaneous biaxial stretching method, sequential biaxial stretching method or inflation method. The stretching ratio is preferably 1.1 to 3.5 times, more preferably 1.2 to 2.5 times.

The film of the present invention may comprises only one kind of the polyarylate containing the repeating unit represented by the aforementioned formula (1), or may comprises two more or more kinds of the polyarylates. Further, the film of the present invention may contain a polymer other than the aforementioned polyarylate in such a degree that the advantages of the present invention should not be degraded. A crosslinkable resin may be added in view of solvent resistance, heat resistance, mechanical strength and so forth.

As for type of the crosslinkable resin, various known resins can be used without particular limitations for both of thermosetting resins and radiation-curable resins. Examples of the thermosetting resins include phenol resins, urea resins, melamine resins, unsaturated polyester resins, epoxy resins, silicone resins, diallyl phthalate resins, furan resins, bismaleimide resins, cyanate resins and so forth. As for the crosslinking method, any reactions that form a covalent bond may be used without any particular limitation, and systems in which the reaction proceed at room temperature, such as those utilizing a polyhydric alcohol compound and a polyisocyanate compound to form urethane bonds, can also be used without any particular limitation. However, such systems often have a problem concerning the pot life before the film formation, and therefore such systems are usually used as two-pack systems, in which, for example, a polyisocyanate compound is added immediately before the film formation. On the other hand, when a one-pack system is used, it is effective to protect functional groups to be involved in the crosslinking reaction, and such systems are marketed as blocked type curing agents. Known as the marketed blocked type curing agents are B-882N produced by Mitsui Takeda Chemicals, Inc., Coronate 2513 produced by NIPPON POLYURETHANE INDUSTRY CO., LTD. (these are blocked polyisocyanates), Cymel 303 produced by Mitsui-Cytec Ltd. (methylated melamine resin) and so forth. Moreover, blocked carboxylic acids, which are protected polycarboxylic acids usable as curing agents of epoxy resins, such as B-1 mentioned below are also known.

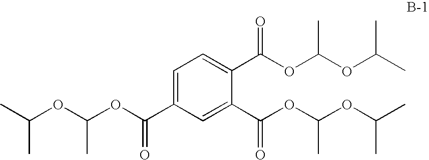

Examples of the radiation curable resins include radically curable resins and cationic curable resins. As a curable component of the radically curable resins, a compound having two or more radically polymerizable groups in the molecule is used, and as typical examples, compounds having 2 to 6 acrylic acid ester groups in the molecule called polyfunctional acrylate monomers, and compounds having two or more of acrylic acid ester groups in the molecule called urethane acrylates, polyester acrylates and epoxy acrylates are used. Typical examples of the method for curing radically curable resins include a method of irradiating an electron ray and a method of irradiating an ultraviolet ray. In the method of irradiating an ultraviolet ray, a polymerization initiator that generates a radical by ultraviolet irradiation is usually added. If a polymerization initiator that generates a radical by heating is added, the resins can also be used as thermosetting resins. As a curable component of the cationic curable resins, a compound having two or more cationic polymerizable groups in the molecule is used. Typical examples of the curing method include a method of adding a photoacid generator that generates an acid by irradiation of an ultraviolet ray and irradiating an ultraviolet ray to attain curing. Examples of the cationic polymerizable compound include compounds containing a ring opening-polymerizable group such as epoxy group and compounds containing a vinyl ether group.

In the film of the present invention, a mixture of two or more kinds of resins selected from each of the aforementioned thermosetting resins and radiation curable resins may be used, and a thermosetting resin and a radiation curable resin may also be used together. Further, a mixture of a crosslinkable resin and a resin not having a crosslinkable group may also be used. The amount of the crosslinkable resin (thermosetting resin or radiation curable resin) is preferably 5 to 200 weight parts, more preferably 10 to 150 weight parts, with respect to 100 parts of the aforementioned polyarylate.

Moreover, it is also possible to introduce crosslinkable groups into the aforementioned polyarylate used in the film of the present invention, and such a polyarylate may have the crosslinkable group at any of end of polymer main chain, positions in polymer side chain and polymer main chain. When such a polymer is used, the polyarylate used in the present invention may not contain the aforementioned commonly used crosslinkable resin.

The film of the present invention can contain a metal oxide/and or composite metal oxide as well as metal oxide obtained by a sol-gel reaction. Addition of such oxides can also imparts heat resistance and solvent resistance like the crosslinkable resin mentioned above.

The film of the present invention may also contain an inorganic layered compound. By adding an inorganic layered compound to the film of the present invention, the thermal deformation temperature thereof is improved by 2 to 100° C. If a resin composition added with an inorganic layered compound is used, it is expected that the film of the present invention can be used as a gas barrier film. Although the inorganic layered compound used for the present invention is not particularly limited, clay minerals, hydrotalcite compounds and other similar compounds having swelling property and/or cleavage property are preferably used.

The film of the present invention may be further added with various additives (resin property modifiers) such as plasticizers, dyes and pigments, antioxidants, antistatic agents, ultraviolet absorbers, inorganic microparticles, release accelerators, leveling agents and lubricants as required in such a degree that the advantages of the present invention are not degraded. Moreover, when the film of the present invention is used as a substrate, a release film or adhesive material can also be added.

Although the thickness of the film of the present invention is not particularly limited, it is preferably 30 to 700 μm, more preferably 40 to 200 μm, still more preferably 50 to 150 μm. The haze of the plastic film substrate is preferably 3% or less, more preferably 2% or less, still more preferably 1% or less, regardless of the thickness. Further, the total light transmission of the film of the present invention is preferably 70% or more, more preferably 80% or more, still more preferably 85% or more, most preferably 90% or more.

A higher heat-resistant temperature of the film of the present invention is more preferred, and it can be tentatively determined by referring to a glass transition temperature determined by DSC measurement. This glass transition temperature is preferably 250° C. or higher, more preferably 300° C. or higher, particularly preferably 330° C. or higher.

If the film of the present invention is produced by the solution casting method using only the aforementioned polyarylate, and drying of the film is sufficient, Tg of the film does not substantially differ from Tg of the used polyarylate, and the difference, if any, should be within the range of measurement error.

The surface of the film of the present invention may be subjected to saponification, corona discharge treatment, flame treatment, glow discharge treatment or the like in order to improve adhesion with other layers or components. An anchor layer may also be provided on the film surface. Further, various known functional layers can be provided depending on the purpose, including a smoothing layer for smoothing the surface, a hard coat layer for imparting anti-scratching property, an ultraviolet ray absorbing layer for enhancing light resistance, a surface roughening layer for improving transportability of the film and so forth.

On the film of the present invention, a transparent conductive layer may be provided. As the transparent conductive layer, known metal films and metal oxide films can be used. Metal oxide films are particularly preferred in view of transparency, conductivity and mechanical characteristics. Examples include, for example, metal oxide films such as those of indium oxide, cadmium oxide and tin oxide added with tin, tellurium, cadmium, molybdenum, tungsten, fluorine, zinc, germanium or the like as impurities, zinc oxide, titanium oxide and so forth added with aluminum as impurities. In particular, thin films of indium oxide consisting mainly of tin oxide and containing 2 to 15 weight % of zinc oxide have superior transparency and conductivity, and therefore they are preferably used.

Although the film formation method for the transparent conductive layer may be any method so long as a desired thin film can be formed, a vapor phase deposition method in which a material is deposited from a vapor phase to form a film, such as the sputtering method, vacuum deposition method, ion plating method and plasma CVD method, is preferred. The film formation can be attained by, for example, the methods described in Japanese Patent No. 3400324, Japanese Patent Laid-open Publication Nos. 2002-322561 and 2002-361774.

The sputtering method is particularly preferred above all, because it can provide superior conductivity and transparency.

Preferred degree of vacuum used for the sputtering method, vacuum deposition method, ion plating method and plasma CVD method is 0.133 mPa to 6.65 Pa, more preferably 0.665 mPa to 1.33 Pa. Before such a transparent conductive layer is provided, the film is preferably subjected to a surface treatment such as plasma treatment (reverse sputtering) and corona discharge treatment. Further, during the preparation of the transparent conductive layer, the temperature may be raised to 50 to 200° C.

The transparent conductive layer formed as described above preferably has a film thickness of 20 to 500 nm, more preferably 50 to 300 nm. Further, the transparent conductive layer has a surface electric resistance of 0.1 to 200 Ω/□, more preferably 0.1 to 100 Ω/□, still more preferably 0.5 to 60 Ω/□, as measured at 25° C. and 60% RH (relative humidity). Furthermore, the transparent conductive layer preferably has a light transmission of 80% or more, more preferably 83% or more, further preferably 85% or more.

The film of the present invention may also be provided with a gas barrier layer in order to suppress gas permeability. Examples of preferred gas barrier layer include, for example, films of metal oxides containing one or more kinds of metals selected from the group consisting of silicon, aluminum, magnesium, zinc, zirconium, titanium, yttrium and tantalum as a main component, and films comprising metal nitrides of silicon, aluminum and boron, and mixtures thereof. Among these, metal oxide films containing silicon oxide containing oxygen atoms at an atomic number ratio of 1.5 to 2.0 with respect to silicon atoms as a main component are preferred in view of gas barrier property, transparency, surface smoothness, flexibility, membrane stress, cost and so forth. Such an inorganic gas barrier layer can be prepared by, for example, a vapor phase deposition method in which a material is deposited from a vapor phase to form a film, such as the sputtering method, vacuum deposition method, ion plating method and plasma CVD method. Among these, the sputtering method is preferred, because it can provide particularly superior gas barrier property. Further, during the preparation of the transparent conductive layer, the temperature may be raised to 50 to 200° C.

The inorganic gas barrier layer obtained as described above preferably has a film thickness of 10 to 300 nm, more preferably 30 to 200 nm. The gas barrier layer may be provided on the same side as the transparent conductive layer, or the side opposite to the transparent conductive layer side.

As for the gas barrier performance of the obtained film, the film preferably has a water vapor permeability of 0 to 5 g/m²·day, more preferably 0 to 1 g/m²·day, still more preferably 0 to 0.5 g/m²·day, as measured at 40° C. and 100% RH, and an oxygen permeability of 0 to 1 mL/m²·day·atm (0 to 1×10⁵ mL/m²·day·Pa), more preferably 0 to 0.7 mL/m²·day·atm (0 to 7×10⁴ mL/m²·day·Pa), still more preferably 0 to 0.5 mL/m²·day·atm (0 to 5×10⁴ mL/m²·day·Pa), as measured at 40° C. and 90% RH. If the gas barrier performance is within the ranges defined above, when the film is used for an organic EL or LCD, degradation of devices by water vapor or oxygen can be substantially eliminated, and thus gas barrier performance in such ranges is preferred.

In order to improve the barrier performance, a defect compensating layer is preferably formed adjacent to the gas barrier layer. As the defect compensating layer, for example, (1) an inorganic oxide layer prepared by using a sol-gel method as disclosed in U.S. Pat. No. 6,171,663 and Japanese Patent Laid-open No. 2003-94572, (2) an organic layer described in U.S. Pat. No. 6,413,645 can be used. These defect compensating layers can be prepared by a method of vapor-depositing a layer under vacuum and curing it with an ultraviolet ray or electron beam, or by coating a layer and then curing it with heating, electron beam, ultraviolet ray or the like. When the defect compensating layer is prepared by using coating, various conventionally used coating methods such as spray coating, spin coating and bar coating can be used.

[Image Display Device]

The film of the present invention can be used for image display devices after various functional layers are provided on the film as required. The image display devices referred to herein are not particularly limited, and they may be conventionally known image display devices. The film of the present invention is applicable to image display devices as a substrate for thin film transistor (TFT) display devices or the like. TFT arrays can be prepared according to the method described in, for example, International Patent Publication in Japanese (Kohyo) No. 10-512104. Further, the substrate may have a color filter for color display. Although the color filter may be produced by using any kind of method, it is preferably produced by a photolithography technique.

Further, flat panel displays showing superior display quality can be produced by using the film of the present invention. Examples of display devices of flat panel displays include liquid crystal display devices, plasma displays, electroluminescence (EL) display devices, fluorescent character display tubes, light emitting diodes and so forth, and other than these, the film can be used as a substrate replacing glass substrates of display devices in which glass substrates have conventionally been used. Furthermore, in addition to flat panel displays, the polyarylate, plastic film substrate and film of the present invention can also be used for solar batteries, touch panel and so forth. As for solar batteries, the present invention can be applied to those disclosed in Japanese Patent Laid-open Publication Nos. 9-148606 and 11-288745, “Problems and Solutions regarding whole plastic product of new organic solar batteries” published by Technical Information Institute Co., Ltd, in 2004 and so forth. As for touch panel, the present invention can be applied to those disclosed in Japanese Patent Laid-open Publication Nos. 5-127822, 2002-48913 and so forth.

When the film of the present invention is used for liquid crystal displays and so forth, the polyarylate is preferably an amorphous polymer so that optical uniformity can be attained. Further, a smaller birefringence of the film is more preferred, and the film of the present invention preferably shows, in particular, an in-plane retardation (Re) of 50 nm or less, more preferably 30 nm or less, still more preferably 15 nm or less. In order to obtain a film showing a small birefringence by using only the polyarylate of the present invention, the birefringence can be controlled by suitably selecting the solvent for the solution casting and suitably adjusting the drying conditions. Moreover, the birefringence can also be controlled by stretching of the film as required. Furthermore, for the purpose of controlling retardation (Re) and wavelength dispersion thereof, resins having positive and negative intrinsic birefringences may be combined, or a resin showing larger (or smaller) wavelength dispersion may be combined. Furthermore, in the film of the present invention, a laminate of different resins may be preferably used in order to control retardation (Re) or improve gas permeability and mechanical characteristics. Moreover, a known retardation film can be used together to compensate phase difference.

The film of the present invention can also be used as a retardation film since optical anisotropy of the film can be controlled. The double refraction of the retardation film is not always small and may be a desired level. Any methods can be used to attain the desired double refraction. Examples of the methods include drawing of the film of the present invention, addition or coating of a compound showing double refraction and so forth.

When the film of the present invention is used for a reflection type liquid crystal display device, the reflection type liquid crystal display device preferably has a structure consisting of, in the order from the bottom, a lower substrate, reflective electrode, lower alignment layer, liquid crystal layer, upper alignment layer, transparent electrode, upper substrate, λ/4 plate and polarizing film. Although the film of the present invention can be used as the aforementioned λ/4 plate and protective film for polarizing film by controlling the optical characteristics thereof, it is preferably used as a substrate in view of the heat resistance thereof, and it is also preferably used as the transparent electrode or the upper substrate having an alignment layer. Moreover, a gas barrier layer, TFT and so forth can also be provided as required. In the case of a color display device, it is preferable to further provide a color filter layer between the reflective electrode and the lower alignment layer or between the upper alignment layer and the transparent electrode.

When the film of the present invention is used for a transmission type liquid crystal display device, the transmission type liquid crystal display device preferably has a structure consisting of, in the order from the bottom, a back light, polarizing plate, λ/4 plate, lower transparent electrode, lower alignment layer, liquid crystal layer, upper alignment layer, upper transparent electrode, upper substrate, λ/4 plate, and polarization film. Although the film of the present invention can be used as the λ/4 plate and protective film for polarizing film by controlling the optical characteristics thereof, it is preferably used as a substrate in view of the heat resistance thereof, and it is also preferably used as the transparent electrode or a substrate having an alignment layer. Moreover, a gas barrier layer, TFT and so forth can also be provided as required. In the case of a color display device, it is preferable to further provide a color filter layer between the lower transparent electrode and the lower alignment layer or between the upper alignment layer and the transparent electrode.

Type of liquid crystal cell is not particularly limited, and various display modes such as TN (Twisted Nematic), IPS (In-Plane Switching), FLC (Ferroelectric Liquid Crystal), AFLC (Anti-ferroelectric Liquid Crystal), OCB (Optically Compensatory Bend), STN (Supper Twisted Nematic), VA (Vertically Aligned) and HAN (Hybrid Aligned Nematic) have been proposed. Furthermore, display modes in which alignment division (multi-domain) is adopted with the aforementioned display modes have also been proposed. The film of the present invention is effectively used in liquid crystal display devices of any display mode. Furthermore, it is also effective in any of liquid crystal display devices of transmission type, reflection type and semi-transmission type.

These display modes are disclosed in Japanese Patent Laid-open Publication No. 2-176625, Japanese Patent Publication No. 7-69536, MVA is disclosed in SID97, Digest of tech. Papers, 28 (1997) 845, SID99, Digest of tech. Papers 30, (1999) 206, Japanese Patent Laid-open Publication No. 11-258605, SURVAIVAL in Monthly Display, Vol. 6, No. 3 (1999) 14, PVA in Asia Display 98, Proc. of the-18th-Inter. Display res. Conf. (1998) 383, Para-A in LCD/PDP Iternational 99, DDVA in SID98, Digest of tech. Papers 29 (1998) 838; EOC in SID98, Digest of tech. Papers, 29 (1998) 319, PSHA in SID98, Digest of tech. Papers, 29 (1998) 1081, RFFMH in Asia Display 98, Proc. of the-18th-Inter. Display res. Conf. (1998) 375, HMD in SID98, Digest of tech. Papers, 29 (1998) 702, Japanese Patent Laid-open Publication No. 10-123478, International Patent Publication WO98/48320, Japanese Patent No. 3022477, International Patent Publication WO00/65384 and so forth.

The film of the present invention can be used for use in an organic EL display as a substrate having a transparent electrode by providing a gas barrier layer, TFT and so forth as required. Specific examples of layer structure of organic EL display device include positive electrode/luminescent layer/transparent negative electrode, positive electrode/luminescent layer/electron transport layer/transparent negative electrode, positive electrode/hole transport layer/luminescent layer/electron transport layer/transparent negative electrode, positive electrode/hole transport layer/luminescent layer/transparent negative electrode, positive electrode/luminescent layer/electron transport layer/electron injection layer/transparent negative electrode, positive electrode/hole injection layer/hole transport layer/luminescent layer/electron transport layer/electron injection layer/transparent negative electrode and so forth.

With an organic EL device for which the film of the present invention can be used, light emission can be obtained by applying a direct current (alternating current component may be included as required) voltage (usually 2 to 40 V) or direct current between the positive electrode and the negative electrode. For driving of such light emitting elements, the methods described in Japanese Patent Laid-open Publication Nos. 2-148687, 6-301355, 5-29080, 7 134558, 8-234685, 8-241047, U.S. Pat. Nos. 5,828,429, 6,023,308, Japanese Patent No. 2784615 and so forth can be used.

### EXAMPLES

Hereafter, the present invention will be further specifically explained by referring to examples. However, the materials, amounts used, ratios, types of processes, order of processes and so forth mentioned in the examples may be optionally changed without departing from the spirit of the present invention. Therefore, the scope of the present invention should not be construed in any limitative way on the basis of the following specific examples.

[Methods for Measuring Characteristic Values]

(1) Weight Average Molecular Weight

Weight average molecular weights were obtained by GPC measurement providing polystyrene-converted molecular weights using HLC-8120 GPC produced by Tosoh Corp. and tetrahydrofuran as solvent and comparison with molecular weight standards of polystyrene.

(2) Glass Transition Temperature (Tg)

Glass transition temperatures were measured by DSC method (in nitrogen gas, temperature increasing rate: 10° C./minute) using DSC 6200 produced by SEIKO Co., Ltd.

(3) Film Thickness

Film thickness was measured by using a dial type thickness gauge, K402B, produced by ANRITSU Corp.

(4) Total Light Transmission of Film

Total light transmission of film was measured by using haze computer of direct reading type HGM-2DP by SUGA TEST Co., Ltd.

(5) Mechanical Characteristics of Film

A film sample (1.0 cm×5.0 cm) was prepared, and mechanical characteristics were measured under a condition of a drawing speed of 3 mm/minute by using Tensilon RTM-25 produced by Toyo Baldwin Co., Ltd. The measurement was performed for 3 samples of the same type, and an average of the measured values was calculated (the samples were left overnight at 25° C. and 60% RH before use, chuck gap: 3 cm).

[Synthesis of Polymers]

In addition to the exemplary compounds P-1 and P-16 mentioned above, exemplary compounds P-2, P-3, P-4, P-11, P-19 and P-23 were synthesized in a manner similar to that of the synthesis method of P-1. The obtained molecular weights and Tg are shown in Table 2.

As a comparative polymer, a polyarylate derived from fluorene bisphenol, isophthalic acid and terephthalic acid (referred to as “BPFL-I/T” hereinafter) was synthesized by the following method.

A-1 containing 8.6 weight % of acetonitrile (253.03 g, 660 mmol), which was obtained in Synthesis Example 1, tetrabutylammonium chloride (9.171 g, 33 mmol), dichloromethane (2227 mL) and water (2475 mL) were put into a reaction vessel provided with a stirrer and stirred at a stirring rate of 300 rpm on a water bath under a nitrogen flow. After 30 minutes, a solution obtained by dissolving isophthalic acid chloride (67.0 g, 330 mmol) and terephthalic acid chloride (67.0 g, 330 mmol) in 743 mL of dichloromethane and 693 mL of 2 M (2 N) aqueous sodium hydroxide diluted with 132 mL of water were simultaneously added dropwise over 1 hour by using separate dropping apparatuses, and after completion of the addition, they were washed off with 165 mL of water and 165 mL of dichloromethane, respectively. Subsequently, stirring was continued for 3 hours, and then dichloromethane (1 L) was added. The organic phase was separated, and a solution obtained by diluting 6.6 mL of 12 M (12 N) aqueous hydrochloric acid with 2.5 L of water was added to the organic phase for washing. The organic phase was further washed twice with 2.5 L of water. Then, dichloromethane (1 L) was added to the separated organic phase for dilution, and the diluted organic phase was poured into vigorously stirred methanol (25 L) over 1 hour. The obtained white precipitates were collected by filtration and dried by heating at 40° C. for 12 hours and then at 70° C. for 3 hours under reduced pressure to obtain 286 g of the comparative polymer, BPFL-I/T.

The molecular weight of the obtained BPFL-I/T was measured by GPC (solvent: THF) and found to be 258,000 in terms of weight average molecular weight. Further, Tg of BPFL-I/T measured by DSC was 324° C.

In the same manner, a polyarylate derived from bisphenol A and isophthalic acid/terephthalic acid (equimolar amounts) (BisA-I/T, having the following chemical formula) and a polyarylate derived from 9,9-bis(3-methyl-4-hydroxyphenyl)fluorene and isophthalic acid/terephthalic acid (equimolar amounts) (BOCFL-I/T) were synthesized. The molecular weights and Tg of the obtained BisA-I/T and BOCFL-I/T are shown in Table 2. 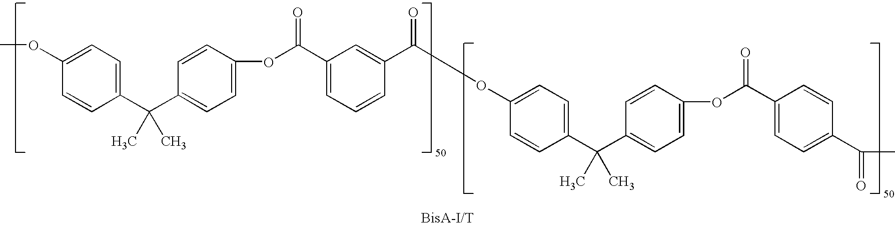
[Preparation of Film Samples (Samples 101 to 114)]

The aforementioned polyarylates and comparative polymers were each dissolved in dichloromethane at a concentration providing a solution viscosity in the range of 500 to 1500 mPa·s. Each solution was filtered through a 5-μm filter and then cast on a glass substrate by using a doctor blade. After the casting, the solution was dried by heating at 80° C. for 2 hours and at 100° C. for 4 hours, and then the film was delaminated from the glass substrate to prepare film samples (Samples 101 to 109 and 112 to 114).

Moreover, Samples 110 and 111 were prepared in the same manner except that the solvent was changed from dichloromethane alone to a 9/1 (volume ratio) mixed solvent of dichloromethane/anisole.

Film thickness, total light transmission, breaking stress and breaking elongation of the obtained film samples were measured. The results are shown in Table 2 together with the molecular weights and Tg of the used polymers.

TABLE 2

| | Polyarylate used | | | Properties of film | | | | |
|---|---|---|---|---|---|---|---|---|
| | | | Glass transition | | Total light | Film | Breaking | Breaking |
| | | Weight average | temperature | | transmission | thickness | stress | elongation |
| Sample No. | Polymer | molecular weight | (° C.) | Solvent | (%) | (μm) | (MPa) | (%) |
| 101 (Comparative) | BisA-I/T | 367000 | 215 | Dichloromethane | 87 | 74 | 74 | 74 |
| 102 (Comparative) | BPFL-I/T | 258000 | 324 | Dichloromethane | 85 | 81 | 86 | 24 |
| 103 (Comparative) | BOCFL-I/T | 228000 | 292 | Dichloromethane | 86 | 89 | 80 | 15 |
| 104 (Invention) | P-1 | 170000 | 369 | Dichloromethane | 73 | 89 | 118 | 28 |
| 105 (Invention) | P-1 | 51000 | 345 | Dichloromethane | 76 | 87 | 110 | 24 |
| 106 (Invention) | P-4 | 58000 | 348 | Dichloromethane | 87 | 92 | 110 | 21 |
| 107 (Invention) | P-11 | 44600 | 345 | Dichloromethane | 88 | 88 | 115 | 24 |
| 108 (Invention) | P-2 | 62000 | 320 | Dichloromethane | 86 | 91 | 120 | 13 |
| 109 (Invention) | P-16 | 258000 | 361 | Dichloromethane | 85 | 82 | 120 | 12 |
| 110 (Invention) | P-1 | 170000 | 369 | Dichloromethane/anisole | 88 | 90 | 116 | 26 |
| 111 (Invention) | P-1 | 51000 | 345 | Dichloromethane/anisole | 87 | 92 | 113 | 22 |
| 112 (Invention) | P-3 | 172000 | 373 | Dichloromethane | 85 | 90 | 113 | 15 |
| 113 (Invention) | P-19 | 63000 | 350 | Dichloromethane | 87 | 96 | 110 | 25 |
| 114 (Invention) | P-23 | 59000 | 340 | Dichloromethane | 87 | 87 | 110 | 23 |

From the results shown in Table 2, it can be seen that all of the films according to the present invention (Samples 104 to 107 and 109 to 114) had a higher Tg than those of the comparative examples (Samples 101 to 103), and superior heat resistance. Sample 108 of the present invention had a lower Tg than Sample 102 of comparative, but had a higher Tg than Sample 103 of comparative having the same bisphenol unit, which shows superior heat resistance of Sample 108.

All of the films according to the present invention (Samples 104 to 114) exhibited a higher breaking stress than those of the comparative examples, which shows superior mechanical of the present invention. Although transparency of Samples 104 and 105 was slightly inferior, transparency was improved by changing the type of the solvent as in Samples 110 and 111, which showed transparency at a level comparable to those of the comparative examples.

[Preparation of Organic EL Device Samples]

(Formation of Gas Barrier Layer)

Gas barrier layers were sputtered on the both surfaces of each of the film samples 101 to 103, 106, 107, 110 and 112 mentioned above by the DC magnetron sputtering method at an output of 5 kW under vacuum of 500 Pa in an Ar atmosphere using SiO₂ as a target. The obtained gas barrier layers had a film thickness of 60 nm.

(Formation of Transparent Conductive Layer)

A transparent conductive layer consisting of an ITO film having a thickness of 140 nm was provided on one side of each film sample provided with the gas barrier layers and heated to 100° C. by the DC magnetron sputtering method at an output of 5 kW under vacuum of 0.665 Pa in an Ar atmosphere using ITO (In₂O₃: 95 weight %, SnO₂: 5 weight %) as a target.

(Heat Treatment of Films Having Transparent Conductive Layer)

Each of the film samples obtained above, which was provided with the transparent conductive layer, was subjected to a heat treatment at 300° C. for 1 hour assuming disposition of TFT.

(Preparation of Organic EL Devices)

An aluminum lead wire was connected to the transparent electrode of each film sample formed with a transparent conductive layer and subjected to the heat treatment described above to form a laminated structure. The film sample formed with a transparent conductive layer obtained from the film sample 101 showed marked deformation, and thus any organic EL device could not be prepared from it. Further, the film samples formed with a transparent conductive layer obtained from the film samples 102 and 103 also showed slight deformation. However, the deformation was not so significant, and therefore organic EL devices were prepared from them.

An aqueous dispersion of polyethylene dioxythiophene/polystyrenesulfonic acid (Baytron P, BAYER, solid content: 1.3 weight %) was applied on the surface of the transparent electrode by spin coating and vacuum-dried at 150° C. for 2 hours to form a hole transporting organic thin film layer having a thickness of 100 nm. This was designated Substrate X.

Further, a coating solution for light-emitting organic thin film layer having the following composition was applied on one side of a temporary support made of polyethersulfone having a thickness of 188 μm (SUMILITE FS-1300, Sumitomo Bakelite) by using a spin coater and dried at room temperature to form a light-emitting organic thin film layer having a thickness of 13 nm on the temporary support. This was designated Transfer Material Y.

| | | |
|---|---|---|
| Polyvinyl carbazole | 40 | parts by weight |
| (Mw = 63000, Aldrich) | | |
| Tris(2-phenylpyridine) iridium | 1 | part by weight |
| complex (Ortho-metalated complex) | | |
| Dichloroethane | 3200 | parts by weight |

The light-emitting organic thin film layer side of Transfer Material Y was overlaid on the upper surface of the organic thin film layer of Substrate X, heated and pressurized under the conditions of 160° C., 0.3 MPa and 0.05 m/min by using a pair of heat rollers, and the temporary support was delaminated to form a light-emitting organic thin film layer on the upper surface of Substrate X. This was designated Substrate XY.

Further, a patterned mask for vapor deposition (mask providing a light-emitting area of 5 mm×5 mm) was set on one side of a polyimide film (UPILEX-50S, Ube Industries) cut into a 25-mm square and having a thickness of 50 μm, and Al was vapor-deposited in a reduced pressure atmosphere of about 0.1 MPa to form an electrode having a film thickness of 0.3 μm. Al₂O₃ was vapor-deposited by DC magnetron sputtering using an Al₂O₃ target with a film thickness of 3 nm in the same pattern as the Al layer. An aluminum lead wire was connected to the Al electrode to form a laminated structure. A coating solution for electron transporting organic thin film layer having the following composition was applied on the obtained laminated structure by using a spin coater and vacuum-dried at 80° C. for 2 hours to form an electron transporting organic thin film layer having a thickness of 15 nm. This was designated Substrate Z.

| | | |
|---|---|---|
| Polyvinyl butyral | 10 | parts by weight |
| (2000L produced by Denki | | |
| Kagaku Kogyo, Mw = 2000,) | | |
| 1-Butanol | 3500 | parts by weight |
| Electron transporting compound | 20 | parts by weight |
| having the following structure | | |

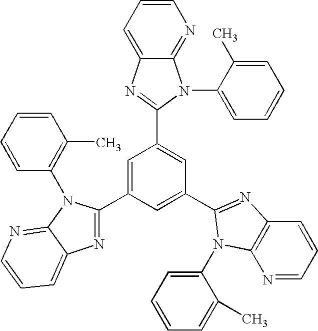

Substrate XY and Substrate Z were stacked so that the electrodes should face each other via the light-emitting organic thin film layer between them, heated and pressurized at 160° C., 0.3 MPa and 0.05 m/min by using a pair of heat rollers to obtain organic EL device samples 202, 203, 206, 207, 210 and 212.

DC voltage was applied to each of the obtained organic EL devices samples 202, 203, 206, 207, 210 and 212 by using Source-Measure Unit Model 2400 (Toyo Corporation) Whereas light emission could not be confirmed for the comparative samples 202 and 203, for which slight deformation was observed, light emission could be confirmed for the samples according to the present invention, 206, 207, 210 and 212.

The aforementioned examples revealed that the films of the present invention were halogen free and had superior heat resistance, transparency and mechanical characteristics. Further, it was also revealed that they could be laminated with a gas barrier layer and transparent conductive layer and could function as substrate films for organic EL devices even if they were subjected to a heat treatment assuming the TFT process.

Because the film of the present invention comprises a polyarylate containing a particular repeating unit, it has superior heat resistance, optical characteristics and mechanical characteristics. Therefore, it can be utilized as a substrate for thin transistor display devices, liquid crystal display devices, plasma displays, electroluminescence (EL) display devices, fluorescent character display tubes, light emitting diodes and so forth.

The present disclosure relates to the subject matter contained in Japanese Patent Application No. 036741/2004 filed on Feb. 13, 2004, which is expressly incorporated herein by reference in its entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A film comprising a polyarylate containing a repeating unit represented by the formula (1):
Formula (1) 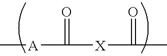
wherein, in the formula (1), X represents a bridging group having the naphthalene or biphenyl structure represented by either one of the following structures: 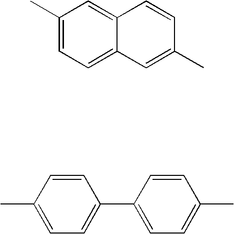
and A represents a bridging group represented by the following formula (2):
Formula (2) 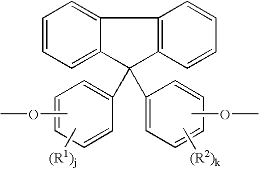
wherein, in the formula (2), R¹ and R² independently represent an alkyl group or an aryl group, j and k independently represent an integer of 0 to 4, and when j and/or k is 2 or larger, two or more of R¹ and/or R² may be the same or different, provided that when j and/or k is 2 or larger, and R¹ and/or R² existing on one of the ortho positions on the aromatic rings with respect to the oxygen atoms represented by —O— is phenyl group, hydrogen atom exists on the other ortho positions.

2. The film according to claim 1, wherein R¹ and R² in the formula (2) are independently methyl group, ethyl group, n-propyl group, isopropyl group, n-butyl group, isobutyl group, sec-butyl group, tert-butyl group, cyclohexyl group, phenyl group or naphthyl group.

3. The film according to claim 2, wherein R¹ and R² in the formula (2) are methyl group.

4. The film according to claim 1, wherein the bridging group in the formula (2) comprises a structure derived from a bisphenol compound represented by any one of the following formulae A-1 to A-14:

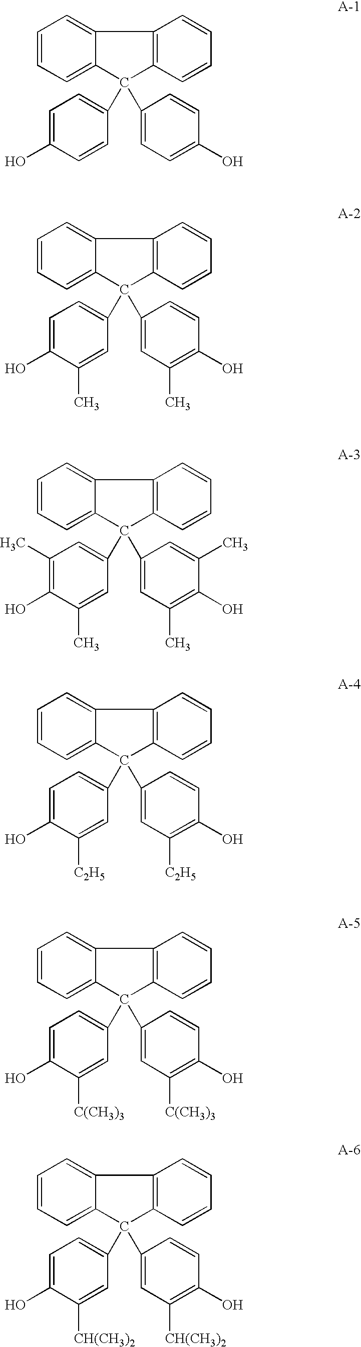

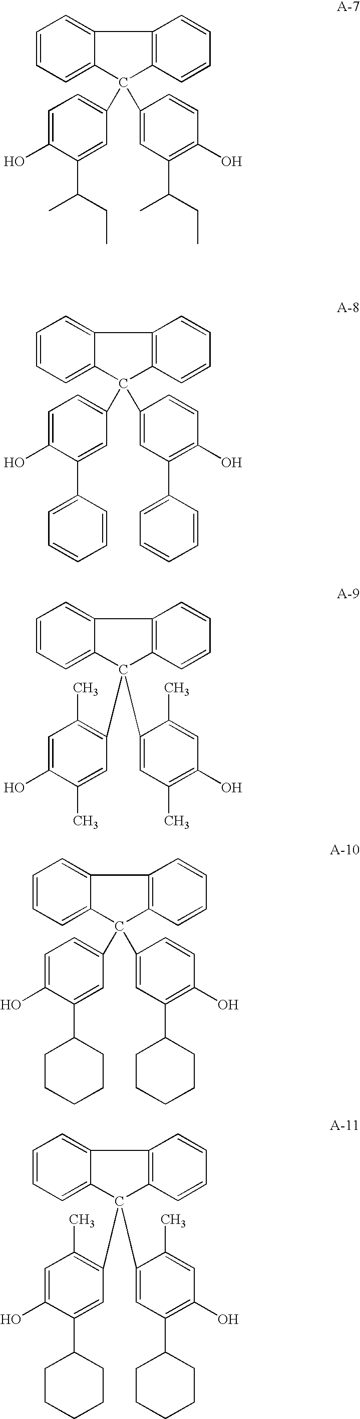

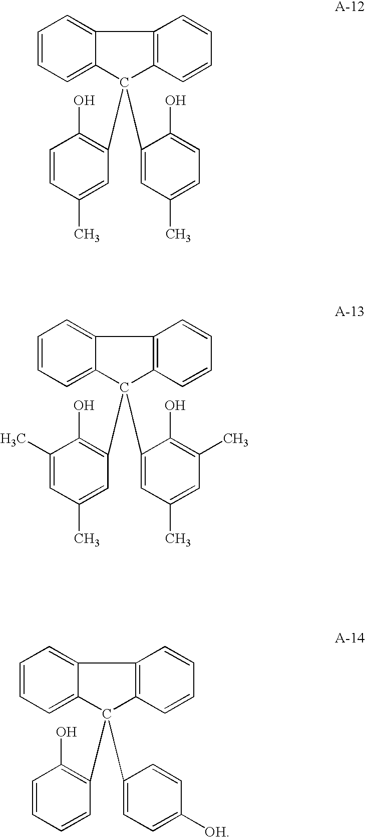

5. The film according to claim 4, wherein the bridging group in the formula (2) comprises a structure de rived from a bisphenol compound represented by A-1, A-2 or A-3.

6. The film according to claim 1, wherein the polyarylate is copolymerized with a dicarboxylic acid other than 2,6-naphthalenedicarboxylic acid and 4,4′-biphenyldicarboxylic acid.

7. The film according to claim 6, wherein the polyarylate is copolymerized with terephthalic acid, isophthalic acid, 2,7-naphthalenedicarboxylic acid and/or diphenic acid.

8. The film according to claim 7, wherein the polyarylate is copolymerized with terephthalic acid.

9. The film according to claim 1, wherein the polyarylate is copolymerized with a bisphenol compound.

10. The film according to claim 1, wherein the polyarylate contains two or more kinds of repeating units represented by the formula (1).

11. The film according to claim 1, wherein the repeating unit represented by the formula (1) is contained in the polyarylate at a molar percentage of 5 to 100%.

12. The film according to claim 1, wherein the polyarylate has a glass transition temperature of 300° C. or higher.

13. The film according to claim 1, wherein the polyarylate has an weight average molecular weight of 10,000 to 500,000.

14. The film according to claim 1, wherein the polyarylate has a carboxyl value of 300 mmol/g or less.

15. The film according to claim 1, which has a total light transmission of 80% or higher.

16. The film according to claim 1, which is laminated with a gas barrier layer on at least one side.

17. The film according to claim 1, which is laminated with a transparent conductive layer on at least one side.

18. A retardation film utilizing the film according to claim 1.

19. An image display device utilizing the film according to claim 1.

20. An organic electroluminescence device utilizing the film according to claim 1.
